(19) United States
(12) Patent Application Publication
(10) Pub. No.: US 2005/0030953 A1
(43) Pub. Date: Feb. 10, 2005

(54) Method of controlling reverse link transmission

(76) Inventors: Subramanian Vasudevan, Morristown, NJ (US); Yunsong Yang, Piscataway, NJ (US)

Correspondence Address: HARNESS, DICKEY & PIERCE, P.L.C., P.O. Box 8910, Reston, VA, 20195, US

(21) Appl. No.: 10/632,813

(22) Filed: Aug. 4, 2003

(51) Int. Cl. H04L 12/56

(52) U.S. Cl. 370/395.4; 370/342

(57) ABSTRACT

The method of controlling reverse link transmission by at least one mobile station includes first scheduling a transmission by at least one mobile station by sending a schedule grant message according to a first scheduling protocol. The schedule grant message provides the mobile station with approval to transmit, and further establishes a rate limit for transmissions scheduled according to a second scheduling protocol.

### BACKGROUND OF THE INVENTION

Development of the releases of the CDMA2000 family of standards, as well as UMTS and other 3^{rd} generation wireless standards, has focused in part on enhancing the reverse link (mobile station to base station) operation to support high-speed packet data applications. For example, as part of the development of 1xEV-DV Release D, a number of framework proposals to enhance the performance of the reverse link are under consideration. These proposals envision using two types of modes or methods for scheduling transmissions by the mobile station: a scheduled transmission mode and a rate control scheduling mode.

The first type, referred to as a scheduled transmission mode, schedules transmissions by having the base station send a schedule grant message with an explicit instruction for the mobile station to transmit. A grant for a scheduled transmission designates the mobile station that is to transmit as well as the transmission format (data rate, frame/packet duration, and transmission power) the mobile station is to employ. The rate of a transmission is the number of information bits that constitute the transmission divided by the time interval over which the bits are sent.

The rate control scheduling mode on the other hand provides a looser form of control on mobile station transmissions. Here, the base station sends a rate control directive or instruction, which is typically a one bit transmission, that can be either broadcast to all mobiles in the cell/sector (common rate control) or transmitted individually to mobile stations (dedicated rate control). The rate control bit has a predefined meaning. For example, according to one proposal the rate control bit indicates whether the mobile station is to transmit at a predetermined rate limit or not transmit at all. The non-zero rate limit is signaled via an actual transmission to the mobile while the zero rate limit is signaled by the base station transmitter's silence. Such a rate control mechanism is termed on-off keying. According to another proposal, the rate control bit indicates whether the mobile station is to transmit at an increased or decreased rate limit. As a further example, such as when the rate control method is being used to affect multiple mobile stations, the rate control bit(s) probabilistically influences the rate limit.

As will be appreciated from the above discussion, the proposals to date envision mutually exclusively using the rate control scheduling mode or the scheduling transmission mode. For example, according to one proposal, the scheduling transmission mode is used with mobile stations that are not involved in a soft hand-off (a mobile is said to be in soft handoff if it is in simultaneous communication with at least two base stations that are not collocated), and the rate control scheduling mode is used with mobile stations involved in a soft hand-off.

### SUMMARY OF THE INVENTION

The present invention provides a method of controlling reverse link transmissions that permits concurrently operating in both the scheduled transmission mode and the rate control scheduling mode. According to the present invention, the two modes have a cooperative functional relationship that reduces the transmission power and/or bandwidth needed on the forward link to schedule mobile transmissions. In many cases, a reduced amount of information may be sent on the forward link in order to schedule a mobile's transmissions.

According to one embodiment, the scheduled transmission mode is used to schedule a transmission and set a rate limit from which the rate control scheduling mode operates. Namely, a mobile station interprets a rate control bit with respect to the rate limit set by the last schedule grant message received. In an alternative embodiment the mobile station transmits, in response to a rate control instruction, based on a rate of a previous transmission made by the mobile station in response to a previous schedule grant message.

According to another embodiment, the schedule grant message overrides a common rate control instruction. In this embodiment, the available load at the base station is used to determine whether to send one or more mobile stations respective schedule grant messages, which override the common rate control instruction for these mobile stations.

### BRIEF DESCRIPTION OF THE DRAWINGS

The present invention will become more fully understood from the detailed description given herein below and the accompanying drawings which are given by way of illustration only, wherein like reference numerals designate corresponding parts in the various drawings, and wherein:

FIG. 1 illustrates communication between the mobile station and the base station in which a first embodiment of the present invention is employed to schedule transmission;

FIG. 2 illustrates the operational process performed at the mobile station according to a first embodiment of the present invention;

FIG. 3 illustrates the operational process performed at the base station according to a first embodiment of the present invention;

FIG. 4 illustrates the operational process performed at the mobile station according to a second embodiment of the present invention; and

FIGS. 5A-5B illustrate the operational process performed at the base station according to a second embodiment of the present invention.

### DETAILED DESCRIPTION OF EMBODIMENTS

The following description may be described as based on a wireless communication system operating in accordance with the cdma2000 1xEV-DV standard. Although the exemplary embodiments of the present invention will be described in this exemplary context, it should be noted that the exemplary embodiments shown and described herein are meant to be illustrative only and are not limiting in any way. As such, various modifications will be apparent to those skilled in the art for application to other communications systems, such as the Universal Mobile Telecommunications System (UMTS) as reflected in the high-speed uplink packet access (HSUPA) system specification, for example, and are contemplated by the teachings herein.

Where used below, a mobile station (or mobile) is a device providing data connectivity to a user. A mobile station may be connected to a computing device such as a laptop, personal computer (PC), or it may be a self-contained data device such as a personal digital assistant (PDA) or cellular phone. Accordingly, a mobile station is equivalent to, and may also be referred to as, an access terminal, wireless mobile, remote station, user, user equipment (UE), subscriber or any other remote user of wireless resources in a wireless communications network. Further, a mobile station may be functionally divided into a computing device such as a PC, which is responsible for point-to-point protocol (PPP) and higher later protocol functionality (IP, TCP, RTP, HTTP, etc.) and an access terminal (AT). The AT is responsible for the airlink and radio link protocol (RLP) layers.

Additionally as used herein, a base station refers to network equipment providing data connectivity between a packet data network (e.g., the Internet) and one or more mobile stations. A base station may be equivalent to, and may also be referred to as a base transmitter station, Node-B, access network or radio access network (RAN). An access network or RAN may be composed of one or more base stations.

Unification of the Control Mechanism for Scheduling and Dedicated Rate Control

A first embodiment of the present invention provides a method of controlling reverse link (mobile station to base station) transmissions that cooperatively unifies the scheduled transmission mode and dedicated rate control scheduling mode transmission mechanisms or methods. According to the present invention, the rate limit set by a schedule grant message in the scheduled transmission mode has a dual function/interpretation. The schedule grant serves not only to direct a mobile station to transmit at a specified rate (and for a certain duration) in the well-known manner, but also sets or resets the rate limit for subsequent transmissions scheduled for the mobile station according to the dedicated rate control scheduling method. Thus, the schedule grant message provides both a rate assignment for the particular transmission as well as a rate limit for later rate control scheduling method transmissions.

According to one embodiment of the present invention, a base station sends schedule grant messages over a forward link uplink scheduling channel (F-USCH), also known as the forward grant channel. Instructions, such as the rate control bit, sent according to the rate control scheduling mode are sent by the base station over a different channel. More particularly, these instructions are sent on a sub-channel of the forward link control and acknowledgement channel (F-UCACH), also referred to as the rate control channel.

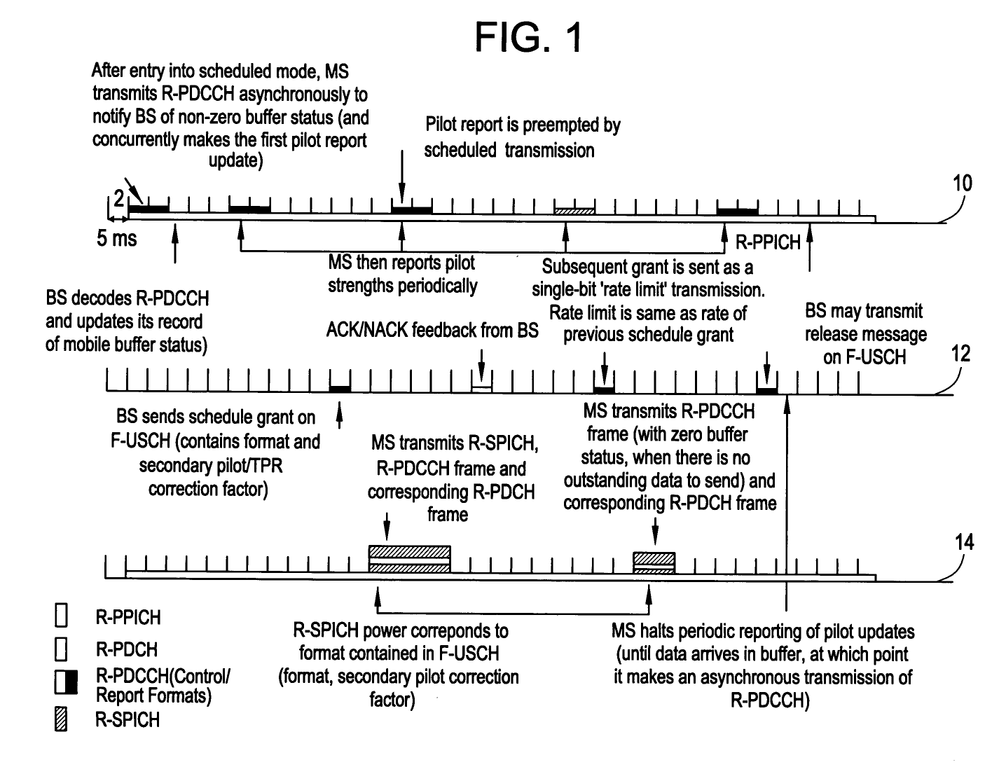

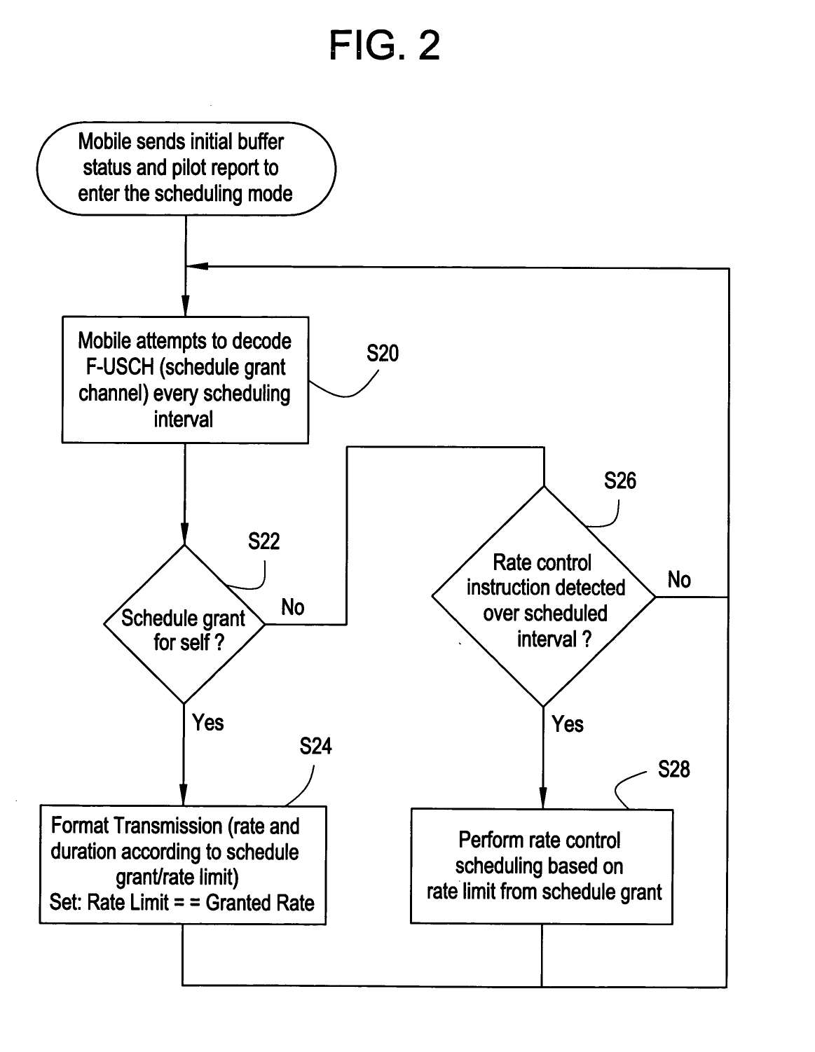

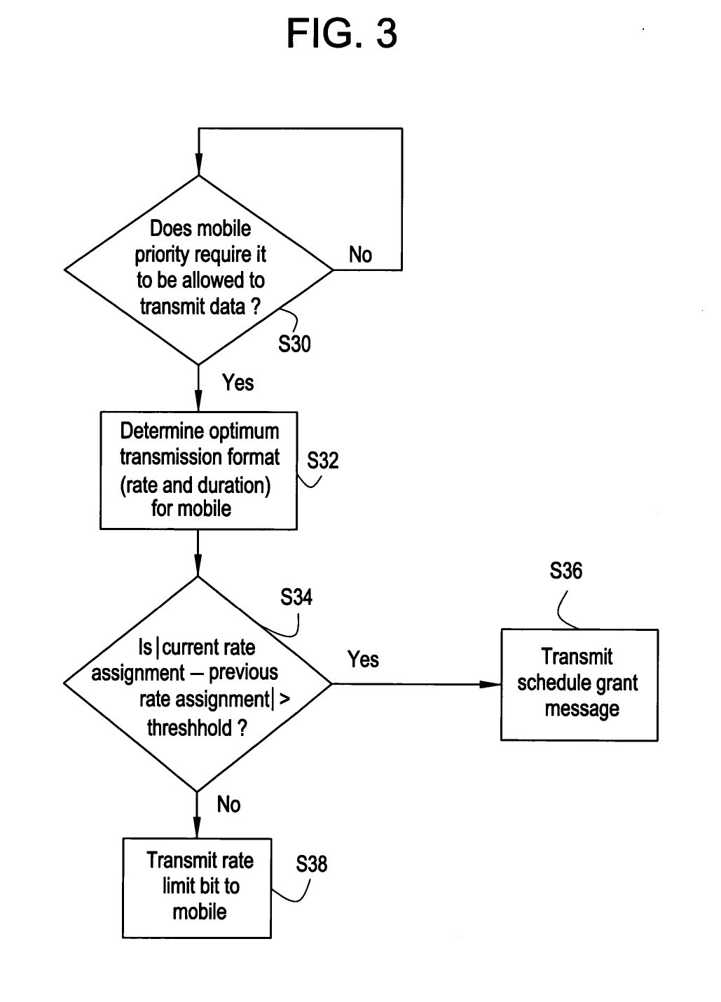

An example operation of the first embodiment of the present invention will be described with respect to FIG. 1. Subsequently, the operational process at the mobile station will be described with respect to FIG. 2, and then the operational process at the base station will be described with respect to FIG. 3.

FIG. 1 illustrates communication between the mobile station and the base station in which the method of the present invention is employed to schedule transmissions. FIG. 1 illustrates a first time-line 10 of transmission performed by the mobile station, a second time-line 12 of transmission performed by the base station, and a third time-line 14 of transmission performed by the mobile station.

As shown, particularly with respect to the first time-line 10, when the mobile station has data to send to the base station, the mobile station enters the scheduled transmission mode and transmits asynchronously over the reverse link packet data control channel (R-PDCCH). The transmission notifies the base station that the mobile station has data to transmit. More particularly, the transmission notifies the base station that the data buffer in the mobile station is not empty, referred to as a non-zero buffer status. In this transmission, the mobile station also makes a first pilot report. A pilot report indicates the signal strength (such as the transmitted power) of a primary pilot signal transmitted by the mobile station to the base station. This signal is referred to as the R-PPICH (Reverse Link Primary Pilot Channel).

As shown by the first time-line 10, the mobile station will continue periodically transmitting pilot reports, and only interrupts the transmission of a pilot report to perform a packet data transmission. As shown by the second time-line 12, the base station decodes the R-PDCCH and updates information maintained on the mobile station. For example, the base station will update information on the buffer status of the mobile station. As a result of this update, in a well-known manner, the base station schedules transmission by the mobile station by sending a schedule grant message on the F-USCH. As is well known, the schedule grant message identifies the mobile station and contains information on the format (rate, duration, and transmission power), and strength with which an additional pilot is to be transmitted. This additional pilot, also termed a secondary pilot (R-SPCIH) provides additional data for estimating the channel at the time of data transmission. According to the present invention, the rate given in the format of the scheduled transmission will serve the dual role of the rate limit for subsequent mobile station transmissions scheduled according to the rate control scheduling method.

An alternative embodiment would use the rate at which the mobile transmits in response to the schedule grant as the reference rate limit. In some cases, it is possible for the mobile to make a transmission at a rate that is lower than the granted data due to the smaller number of bits and/or reduced power available for the transmission.

In response to the schedule grant message, as shown by the third time-line 14, the mobile station transmits reverse link secondary pilot channel (R-SPICH) and R-PDCCH frames and a corresponding reverse link packet data channel (R-PDCH) frame. As is well-known, the R-PDCCH carries the control and format information for the data being transmitted by the mobile station over the R-PDCH. As is further well-known, the R-SPICH is a secondary pilot channel sent by the mobile station. However, according to the present invention, the mobile station sets the power at which the secondary pilot channel is transmitted based on the rate indicated in the schedule grant message. Specifically, the mobile station includes a look-up table mapping rate to secondary pilot channel powers.

The base station receives and decodes the mobile station transmission and sends acknowledgement (ACK) or negative-acknowledgement (NACK) feedback to the mobile station. An ACK indicates that the transmission was received and decoded successfully. A NACK indicates that the transmission was not properly received and/or decoded. As is well-known, in response to a NACK, the mobile station will attempt a re-transmission. In this descriptions re-transmissions are asynchronous, i.e. the re-transmission may follow an arbitrary time after the transmission, and the base station will indicate to the mobile when it should make the retransmission.

The mobile station continues to send pilot reports to the base station as shown in the first time-line 10. The base station may schedule another transmission by the mobile station by either sending a schedule grant message or by utilizing the rate control scheduling method. As will be appreciated, and as described in greater detail below, in accordance with the principals of this embodiment of the present invention, the mobile station will monitor both the F-USCH and the F-UCACH.

As will further be appreciated, scheduling in the rate control scheduling mode is much simpler and requires fewer resources (e.g., power, bandwidth, duration of the channel is used) to schedule a transmission. FIG. 1 illustrates that the subsequent scheduling of the mobile station is performed according to the rate control scheduling method. As shown in the second time-line 12, the base station sends a single-bit rate control instruction. In one embodiment of the present invention, the mobile station operates according to the on-off keying technique. Accordingly, when the rate control bit is set/transmitted (as opposed to silence), the mobile station interprets the rate control instruction as scheduling a transmission with a rate limit as set in the previously received schedule grant message.

The present invention, however, is not limited to this embodiment of rate control scheduling. Instead, the rate control bit or bits may indicate whether the mobile station is to transmit at an increased or decreased rate limit with respect to the rate limit set in the previously received schedule grant message. Thus the scheme would use the rate control bits to increase or decrease the rate limit with respect to the rate limit set in the previously received schedule grant if the previous transmission is made in response to the schedule grant, or with respect to the previous rate limit if the previous transmission is made in response to the rate control bit. Also, the adjustments to the rate limit set by the previously received schedule grant can be cumulative so that all rate control bits received between the current transmission instant and the previously received schedule grant are used to determine the current rate limit. Alternatively, the rate control bits may indicate an increase or decrease with respect to the rate of the mobile station's last transmission, and the adjustments to the rate limit, due to successive rate control bits may accumulate. As a further example, the rate control bit or bits may be used to probabilistically influence the rate limit set in the previously received schedule grant message if the previous transmission is made in response to the schedule grant, or probabilistically influence the previous rate limit if the previous transmission is made in response to the rate control bit(s). The rate control bit(s) may also indicate a change (or no change) with respect to the rate with which the mobile station made its transmission in response to the schedule grant.

If the mobile station still has data in its buffer, then in response to the rate control instruction, the mobile station transmits R-SPICH and R-PDCCH frames and a corresponding reverse link packet data channel (R-PDCH) frame in the same manner described previously. If this transmission will empty the buffer of the mobile station, the mobile station indicates a zero buffer status in the R-PCCH frame.

Assuming the transmission by the mobile station is received and decoded, the base station, besides acknowledging the transmission, sends a release message for the mobile station over the F-USCH in response to the indicated zero buffer status. In response to the release message, the mobile station will halt the periodic sending of the pilot updates.

As discussed above, the base station may schedule subsequent transmissions according to either the rate control scheduling method or the scheduled transmission method. If the scheduled transmission method is reused, then the schedule grant message sent will serve to reset the rate limit upon which the rate control scheduling method is based. Furthermore, while an asynchronous operation of rate control scheduling was described above and will be described in further detail below, performing scheduling according to the principals of the present invention for synchronous rate control scheduling will be readily apparent from the proceeding and following disclosure.

Next, the operational process at the mobile station will be described with respect to FIG. 2. As shown, after the mobile station sends the initial buffer status and the pilot report to enter the scheduling mode, the mobile station monitors the F-USCH and attempts to decode the F-USCH every scheduling interval in step S20. Then, in step S22, the mobile station determines if the decoded schedule grant message is for itself. If so, then in step S24 the mobile station performs a transmission according to the transmission format (rate, duration, etc.) set in the schedule grant message, and will set the rate limit as that indicated by the schedule grant message.

If in step S22 the mobile station does not determine that a schedule grant message is intended for itself, then in step S26, the mobile station monitors the F-UCACH for a rate control instruction. If a rate control instruction is sent during the scheduling interval, then the mobile station uses the rate limit from the previous schedule grant message as the rate limit for performing a transmission according to the rate control scheduling method. Alternatively, the rate control scheduling method employed may, for example, be any of the above-discussed embodiments. For instance, the rate control could be performed with respect to the previous rate limit if the previous transmission is made in response to the rate control bit, and/or the adjustments to the rate limit set by the previously received schedule grant can be cumulative so that all rate control bits received between the current transmission instant and the previously received schedule grant are used to determine the current rate limit. If no rate control instruction is received in step S26, then processing returns to step S20. Processing also returns to step S20 after steps S24 and S28.

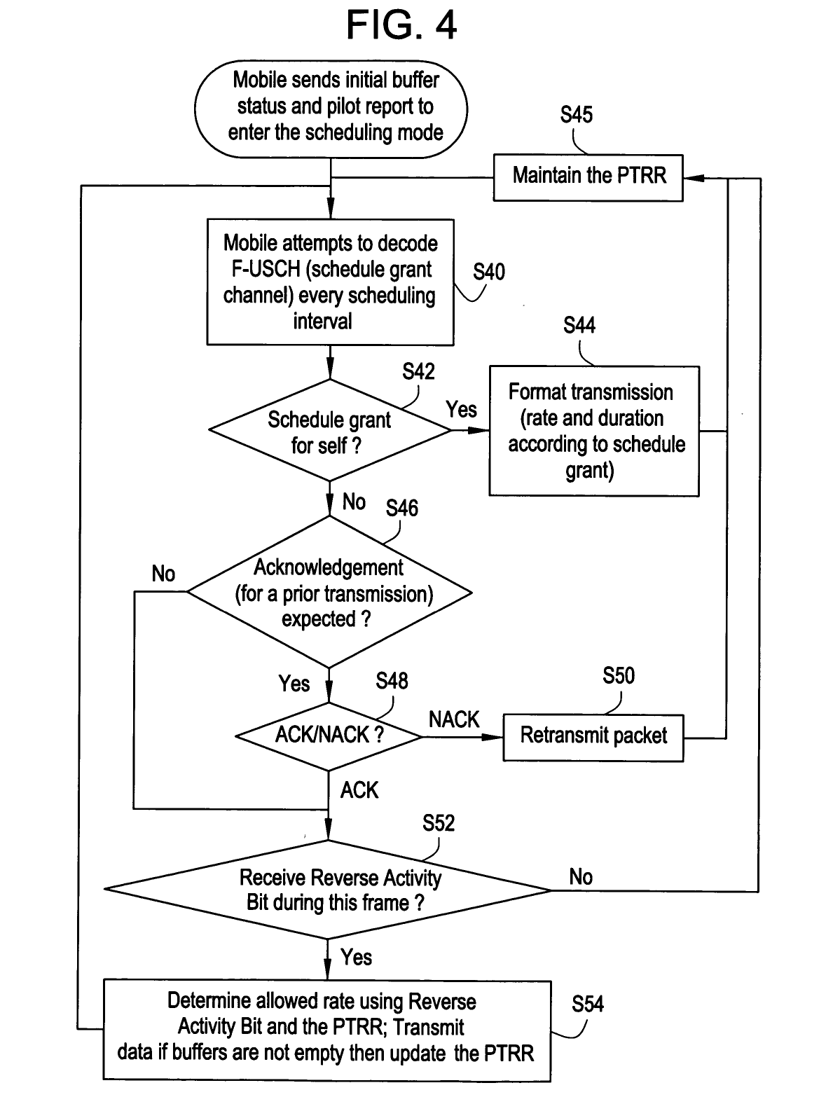

While the operational process has been described for asynchronous rate control scheduling, it will be appreciated from the previous and following disclosure that synchronous rate control scheduling could be performed. For example, the second embodiment of the present invention described in detail below will discuss a synchronous rate control operation that is readily applicable to this embodiment of the present invention. For instance, step S46, S48 and S50 of FIG. 4 may be added between steps S22 and S26 of the present invention to obtain a synchronous rate control operation.

Next, the operational process at the base station will be described with respect to FIG. 3. As shown, the base station uses any well-known method to prioritize the scheduling of transmissions by mobile stations, and determines in step S30 if the priority established for the mobile station permits scheduling of transmission by the mobile station. Once the priority of the mobile station permits scheduling transmission, the base station determines in any well known manner the optimum transmission format (rate, duration and power) for the mobile station transmission in step S32.

Then, in step S34, the base station determines if an absolute value of the currently determined rate minus the previous rate (i.e., rate limit) assigned to the mobile station is greater than a predetermined threshold. Namely, the base station determines if the change in assigned rate limit exceeds a threshold amount. If so, then the base station schedules transmission of the mobile station according to the scheduled transmission mode by sending a scheduling grant message over the F-USCH in step S36. If the change in assigned rate limit does not exceed the threshold amount, then the base station schedules transmission of the mobile station according to the rate control scheduling method by sending a rate control instruction in step S38.

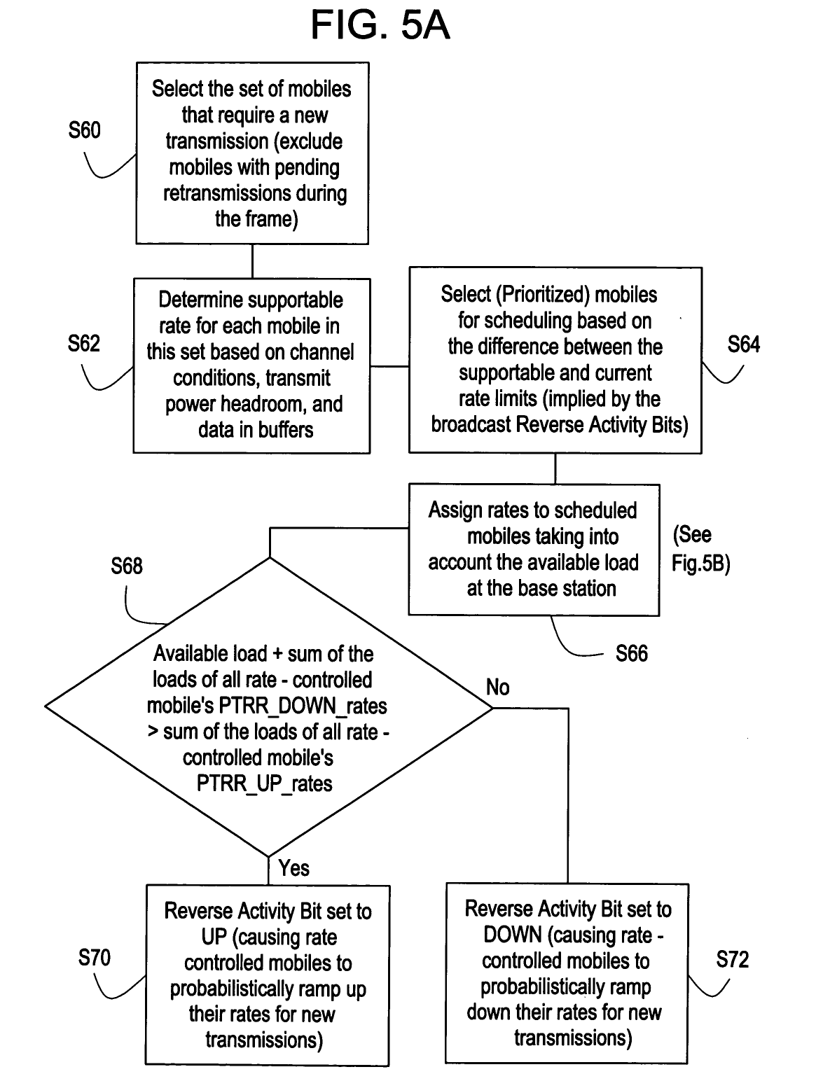

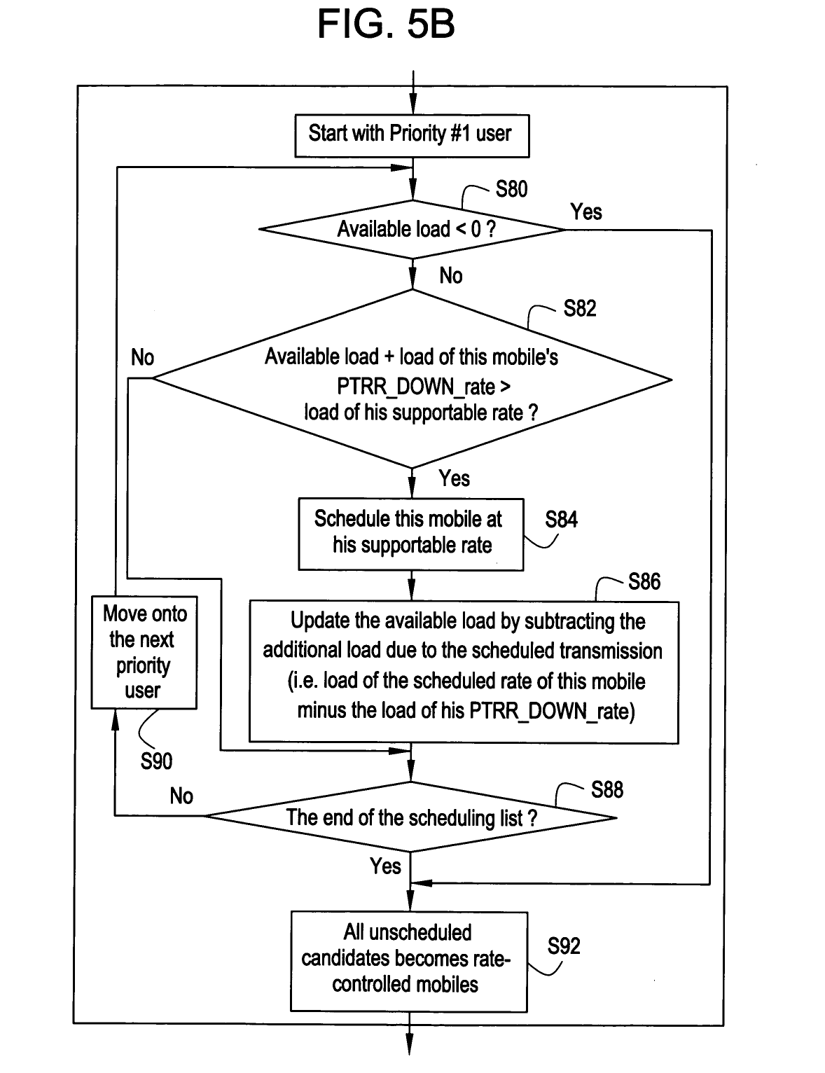

The previously described base station procedure shows how a decision is made to send a rate control command versus a schedule grant to a user that has been deemed high priority and required to transmit data. The description was in the context of a system that combined scheduling with dedicated on-off rate control with asynchronous operation. The base station procedures may also include procedures for determining the control messages to be sent to all the users taking into account the maximum load at the base station as well as the currently assigned rate limits. The maximum load is a measure of the received power that the base station can tolerate for normal operation of the reverse link for all mobiles in the cell. The maximum load and current rate limits are metrics that would determine the pools of users to be scheduled versus rate controlled, the actual rate limits for all users, and the control message (schedule grant or rate control command) to be sent to the users. The next embodiment of the present invention will describe base station procedures for determining the control messages to be sent to all the users taking into account the maximum load at the base station as well as the currently assigned rate limits. This procedure is described with respect to FIGS. 5A and 5B and is readily applicable to the above described embodiment of the present invention. For example, the above-described embodiment of the present invention may adopt the procedures of FIGS. 5A and 5B, except that steps S68-S72 would be replaced with the steps of (i) prioritizing the rate control mobiles based on channel conditions, transmit power headroom, data in their respective buffers, etc. in the any well-known manner; and (ii) determine individual rat control bit(s) based on the mobile priority and the available load at the base station. Namely, in step (ii) the highest priority mobiles are considered first, and if the available load permits rate control scheduling of the mobile, then the mobile is rate controlled schedule; otherwise, the mobile is not scheduled.

Unification of the Control Mechanism for Scheduling and Common Rate Control

A common rate control or scheduling mechanism is one where the data transmissions of a number of mobile stations are scheduled or controlled by a single or common set of rate control bits. One example of common rate control is the HRPD (high rate packet data) system based on the IS-856 standard. In this system, the rate control bits known as reverse activity bits (RAB) are broadcast to all mobile stations in a sector. The received RAB bits (indicating to adjust power up or down) are used by the mobile stations to ramp up or ramp down their data transmission rates with pre-determined transition probabilities. The data rates used by the mobile stations typically move up and down in tandem within a small band of data rates. Common rate control is also under consideration for the enhanced reverse link of 1xEV-DV Revision D (IS-2000-D).

A weakness of a common rate control scheme is its inability to give priority to individual mobile station's data transmissions. Low-latency, high data transmissions by a single (or small number of) mobile station(s) is often desirable in order to meet quality of service (QoS) requirements.

According to a second embodiment of the present invention, the control mechanisms for scheduled transmission and common rate control scheduling are integrated by using a schedule grant message to override the rate limit implied by the sequence of common rate control bits received by the mobiles.

For the purposes of example only, the second embodiment of the present invention will be described using the common rate control scheduling scheme of HRPD as an exemplary common rate control scheduling scheme, but it will be recognized that the present invention is not limited to this common rate control scheduling scheme.

The second embodiment of the present invention will also be described in the context of a system with synchronous acknowledgements and retransmissions. An acknowledgement is said to be synchronous if there exists a fixed timing relationship between transmission of a data packet and the acknowledgement of its successful or unsuccessful receipt at the receiver. Similarly synchronous retransmissions occur a fixed time interval after unsuccessful reception of a data transmission.

The use of the control mechanism described here may be extended in a straightforward manner to the cases where either the acknowledgements, retransmissions, or both are asynchronous, i.e. do not maintain a fixed timing relationship with the initial data transmission.

Examples of the mobile station and base station procedures to be used when a schedule granting mechanism is integrated in a system with common rate control scheduling will be described with respect to FIGS. 4 and 5A-5B, respectively.

FIG. 4 illustrates the operational process performed at the mobile station according to a second embodiment of the present invention. As shown, the mobile station monitors the F-USCH and attempts to decode the F-USCH every scheduling interval in step S40. Then, in step S42, the mobile station determines if the decoded schedule grant message is for itself. If so, then in step S44 the mobile station performs a transmission according to the transmission format (rate, duration, etc.) set in the schedule grant message. However, the mobile station continues to maintain a rate limit that is the previously transmitted rate control rate (PTRR) in step S45. The PTRR is defined as the actual data rate of the mobile station's previous transmission on the R-PDCH while acting upon the rate control instruction (e.g., RAB). When the mobile transmits on the R-PDCH while acting upon the explicit scheduling grant message or, as described later, upon the re-transmission command (i.e., NACK signal sent by the base station), the PTRR is not changed.

If in step S42 the mobile station does not determine that a schedule grant message is intended for itself, then in step S46, the mobile station determines whether an acknowledgement for a prior transmission is expected. If so, then in step S48, the mobile station determines if an ACK or NAK is received. If a NACK is received, then as described above, the mobile station retransmits based on the schedule grant for the NACKed transmission in step S50. Particularly, the rate from the scheduled grant message is used for the retransmission. However, the mobile station does maintain the rate limit that is the PTRR in step S45.

If an ACK is received in step S48 or no acknowledgement is expected in step S46, then in step S52 the mobile station monitors the RAB. If RAB are sent during the scheduling interval, then the mobile station determines the transmission rate limit from the RAB and the PTRR in any well known manner, and transmits data on the R-PDCH using a rate that is equal to or less than the rate limit if the mobile station's buffer is not empty. The PTRR is then updated to the actual transmission rate. If, in step S52, the mobile station does not detect RAB on the F-UCACH, then processing proceeds to step S45. After steps S45 and S54, processing proceeds to step S40.

As described above, if a schedule grant message is received, the rate in the schedule grant message overrides the rate limit from the received RAB bits meanwhile the PTRR is not updated. And, for subsequent frames, if no further scheduling grant messages are received, the rate limit is determined from the received RAB bits and the PTRR then the PTRR is updated, except if a retransmission of a previously scheduled transmission is required.

Next, the operational process at the base station will be described with respect to FIGS. 5A-5B. As shown, the base station, in any well known manner (e.g., based on the previous decoding results), determines the set of mobile stations that require a new transmission excluding mobile stations with pending retransmission during the frame in step S60. Then in step S62, the base station determines the supportable rate for each mobile station in the set based on the channel conditions, transmit power headroom, data in the buffer of each mobile station, etc. Because step S62, like step S60, is so well known, this step will not be described in detail.

Subsequently, in step S64, the base station prioritizes the mobile stations for scheduling. In one embodiment of the present invention, the prioritizing is performed based on the rate difference between the supportable rate determined in step S62 and the current rate limit set forth by the RAB. Specifically, the base station ranks the mobile stations having the greatest rate difference from highest priority to lowest priority, and places the ranked mobile stations having a rate difference greater than a predetermined threshold on a scheduling list.

Next, in step S66, the base station determines which mobile stations on the scheduling list to schedule according to the scheduled transmission method and which mobile stations to schedule according to the common rate control scheduling method. Furthermore, in step S66, the base station determines the rate among other things (e.g., transmission format) for the mobile stations being scheduled according to the scheduled transmission method. FIG. 5B illustrates a flow chart showing the process steps performed by the base station in performing step S66.

As shown in FIG. 5B, the base station starts with the highest priority mobile station on the scheduling list as the mobile station under consideration; hereinafter, the considered mobile station. Then, in step S80, the base station determines if the available load is less than zero. In general, load is the accumulated signal power of each mobile station's transmission. However, a base station has a maximum load that it can support. The available load is the maximum supportable load minus a currently expected load from mobile station transmissions. At the beginning of the scheduling procedure, the available load is determined as the maximum load minus the combination of
the load that retransmissions of data packets would cause; and
the sum of PTFRR_DOWN_rate loads of the mobile stations in the set (see step S60) of mobile stations.

PTRR_DOWN_rate load is defined as the load contribution of a new transmission if the transmission were made in response to RAB of DOWN sent by the base station and the mobile station made the new transmission by acting upon this DOWN command probabilistically with respect to its PTRR. More specifically, as is well known with respect to common rate control according to HRPD,
PTRR_DOWN_rate load=(the probability that mobile transmits at (PTRR down by one step rate) times the load of (PTRR down by one step rate))+(the probability that mobile transmits at PTRR rate times the load of PTRR rate)
Similarly,
PTRR_UP_rate load=(the probability that mobile transmits at (PTRR up by one step rate) times the load of (PTRR up by one step rate))+(the probability that mobile transmits at PTRR rate times the load of PTRR rate)
It will further be appreciated, as is well known with respect to common rate control according to HRPD, the rate transition probabilities for each PTRR can be different and are known at both the base station and the mobile station

If in step S80, the base station determines that the available load is not less than zero, then in step S82, the base station determines if the available load plus the PTRR_DOWN_rate load of the considered mobile station is greater than the load if the considered mobile station made a transmission at its supportable rate (which was determined in step S62).

If the determination in step S82 is positive, then in step S84, the base station schedules the considered mobile station for transmission according to the scheduled transmission method and at the considered mobile station's supportable rate. Next, in step S86, the base station updates the available load by (i) adding the PTRR_DOWN_rate load of the considered mobile station and (ii) subtracting the load if the considered mobile station made a transmission at its supportable rate.

Then in step S88, the base station determines if the any other mobile stations remain on the scheduling list. If so, then in step S90, the next mobile station in terms of priority on the scheduling list becomes the considered mobile station, and processing returns to step S80.

Returning to step S82, if the determination in this step is negative, then processing proceeds directly to step S88. An alternative at this step is to determine a lower supportable rate for the mobile that would satisfy the test of step S82. If such a rate exists and is substantially different from the mobile's current rate limit, then step S84 is entered. If not, step S88 is entered. In step S88, if the scheduling list has been exhausted, then processing proceeds to step S92. Also, if in step S80, the base station determines that the available load is less then zero, then processing proceeds to step S92.

In step S92, the base station treats the unscheduled mobile stations on the scheduling list as rate controlled mobiles. Namely, these mobile stations will be scheduled according to the common rate control scheduling method, as will the mobile stations that did not make the scheduled list but formed part of the set of mobile stations determined in step S60.

Returning to FIG. 5A, after step S66, the base station determines in step S68 if (i) the available load resulting from step S66 plus (ii) the sum of the PTRR_DOWN_rate loads of the rate controlled mobile stations is greater than the sum of the PTRR_UP_rate loads of the rate controlled mobile stations. If so, then in step S70, the base station schedules the rate controlled mobiles according to the common rate control scheduling method by sending RAB set to UP. If the determination in step S68 is negative, then in step S72, the base station schedules the rate controlled mobile stations according to the common rate control scheduling method by sending RAB set to DOWN. In an alternative approach to steps S68-S72 where the RAB is a three-state (Up, Hold, and Down) indication, two thresholds are tested. Here, if the available load plus the sum of loads of all rate-controlled mobiles' PTRR_Down_rates is greater than the sum of loads of all rate-controlled mobiles' PFRR_Up_rates, RAB is set to Up; else if the available load plus the sum of loads of all rate-controlled mobiles'PTRR_Down_rates is greater than the sum of loads of all rate-controlled mobiles' PTRRs, the RAB is set to Hold; else the RAB is set to Down. Other rate control alternatives, such as those described previously in this disclosure, may also be used in place of steps S68-S72.

As will be appreciated, in the second embodiment, the available load determines the assigned rates. Namely, scheduling of individual mobile stations is possible in conjunction with common rate control scheduling. After an individual rate is assigned to each scheduled mobile station, the available load is recalculated by subtracting the additional load that is due to the newly scheduled transmission. Rate-controlled mobile stations are then defined as those mobile stations that are not scheduled or are not re-transmitting.

In the second embodiment, an alternative method for the mobile to determine the power level on the R-SPICH can be based on the power levels for the rates that the mobile can possibly choose to transmit and the probabilities that the mobiles choose those rates. More specifically, mobile_R-SPICH_power=sum of (R-SPICH power if rate i is transmitted times the probability that the mobile chooses rate i to transmit) over i, for i is any rate that the mobile can choose to transmit in response to the RAB and the PTRR. Since the transition probabilities are known to both the base station and mobile station, there is no ambiguity regarding what power level to be used on the R-SPICH. After the mobile selects a particular rate j, the mobile will apply an adjustment to the traffic-to-pilot ratio on the packet data channel to ensure the power level of the packet data channel is correct for the fmal selected rate j (i.e. to correct any deficits if the R-SPICH power of rate j is higher than the MS_R-SPICH_power or any surpluses if the R-SPICH power of rate j is lower than the MS_R-SPICH_power).

The invention being thus described, it will be obvious that the same may be varied in many ways. Such variations are not to be regarded as a departure from the spirit and scope of the invention, and all such modifications are intended to be included within the scope of the following claims.

1. A method of controlling reverse link transmission by at least one mobile station, comprising:
first scheduling a reverse link transmission by at least one mobile station by sending a schedule grant message according to a first scheduling protocol, the schedule grant message providing the at least one mobile station with approval to transmit, the schedule grant message further establishing a rate limit for transmissions scheduled according to a second scheduling protocol.

2. The method of claim 1, wherein the first scheduling protocol is a scheduling mode protocol and the second scheduling protocol is a rate control mode protocol.

3. The method of claim 1, further comprising:
second scheduling a subsequent reverse link transmission by the mobile station by sending a rate control instruction according to the second scheduling protocol.

4. The method of claim 3, wherein the first scheduling step sends the schedule grant message over a first forward control channel and the second scheduling step sends the rate control instruction over a second forward control channel.

5. The method of claim 3, wherein the rate control instruction indicates to transmit at the rate limit.

6. The method of claim 5, wherein a failure to send a rate control instruction indicates not to transmit.

7. The method of claim 3, wherein the rate control instruction indicates one of an increase and a decrease in the rate limit.

8. The method of claim 3, further comprising:
sending another schedule grant message that resets the rate limit.

9. The method of claim 3, further comprising:
determining a change in rate limit between a previously scheduled transmission and a currently scheduled transmission; and
performing the second scheduling step when the determined change does not exceed a threshold amount.

10. The method of claim 1, further comprising:
sending another schedule grant message that resets the rate limit.

11. A method of controlling reverse link transmission by at least one mobile station, comprising:
scheduling a reverse link transmission by at least one mobile station by sending a schedule grant message according to a first scheduling protocol, the schedule grant message providing the at least one mobile station with approval to transmit, the schedule grant message resetting a rate limit for transmissions scheduled according to a second scheduling protocol.

12. The method of claim 11, wherein the first scheduling protocol is a scheduling mode protocol and the second scheduling protocol is a rate control mode protocol.

13. A method of making reverse link transmission, comprising:
transmitting based on a rate limit set by a previously received schedule grant message if a rate control instruction is received.

14. The method of claim 13, wherein the previously received schedule grant message is received over a first channel and the rate control instruction is received over a second channel.

15. The method of claim 13, further comprising:
reducing the rate limit if no rate control instruction is received; and
increasing the rate limit if a rate control instruction is received.

16. The method of claim 13, further comprising:
adjusting the rate limit based on an accumulation of rate control instructions received since the previously received schedule grant message.

17. A method of making reverse link transmission, comprising:
transmitting based on a rate of a previous transmission made in response to a previously received schedule grant message if a rate control instruction is received.

18. A method of controlling reverse link transmission by at least one mobile station, comprising:
overriding a common rate control instruction for the at least one mobile station by sending a schedule grant message for the at least one mobile station.

19. The method of claim 18, further comprising:
first determining whether to override a common rate control instruction for a mobile station based on an available load at a base station; and
performing the overriding step for a mobile station when the determining step determines to override the common rate control instruction for the mobile station.

20. The method of claim 19, wherein the determining step determines whether to override the common rate control instruction for the mobile station based on the available load at the base station, an estimated increase in the available load if the mobile station ignores the common rate control instruction and an estimated reduction in the available load if the mobile station transmits in response to a schedule grant message.

21. The method of claim 19, further comprising:
second determining, for each mobile station in a set of mobile stations to be scheduled, whether to consider the mobile station for overriding the common rate control instruction based on a rate supported by the mobile station and a rate limit set forth according to a previous common rate control instruction; and
performing the first determining step with respect to the mobile stations determined in the second determining step.

22. A method of controlling reverse link transmission by at least one mobile station, comprising:
first transmitting, at a mobile station, according to a schedule grant message instead of a common rate control instruction.

23. The method of claim 22, wherein the transmitting step is a retransmission of a negative-acknowledged transmission sent in response to a schedule grant message.

24. The method of claim 22, further comprising:
second transmitting, subsequent to the first transmitting, according a common rate control instruction and a rate of transmission in response to a previous common rate control instruction.

25. The method of claim 22, further comprising:
setting a secondary pilot level based on a weighted average of the secondary pilot levels corresponding to possible transmission rates.

26. A method, comprising:
transmitting a pilot signal on the reverse link at a power derived from a rate assigned to the mobile station for a scheduled transmission.
